(19) United States
(12) Patent Application Publication
(10) Pub. No.: US 2009/0292618 A1
(43) Pub. Date: Nov. 26, 2009

(54) System & method for multiple users to conduct online browsing & shopping together in real time

(75) Inventor: Wael Chatila, Mountain View, CA (US)

Correspondence Address: Wael Chatila;GinzaWalk LLC, 612 Sierra Vista Ave Unit I, Mountain View, CA, 94043, US

(73) Assignee: GINZA WALK, LLC, Mountain View, CA (US)

(21) Appl. No.: 12/125,061

(22) Filed: May 22, 2008

(51) Int. Cl. G06Q 30/00

(52) U.S. Cl. 705/26

(57) ABSTRACT

A system & method for multiple users to conduct online browsing & shopping together in real time from multiple devices is described. For example, a mother and daughter at remote locations can browse the online stores together simultaneously as if they are shopping at a local shopping center in person. A user accesses the Internet from their device, such as a personal computer using software such as a web browser. Said user initiates a shopping session by activating the client component of the system. Said client component in turn activates a server component to provide a specific session identification code. Said session identification code is shared by the initiating user with additional individuals or groups with whom the initiating user wishes to invite to a simultaneous online browsing or shopping.

These additional invited individuals or groups utilize their own devices, such as personal computer connected to the Internet and a web browser, to access the online browsing and shopping session from the server component of the system described herein using the identification code shared by the initiating user. The server component transmits to the invited individuals copies of the Internet pages as the initiating user views them. Both the initiating user and the invited individuals can view where each other's computer pointing devices are on the Internet page as if they were pointing at specific merchandise in the store. The initiating user also has the ability to allow invited users to navigate to other Internet pages representing other sections of the online, or other stores altogether. Thus, the system provides a fully interactive real time online social shopping experience, and is available at http://www.ginzawalk.com

### BACKGROUND

1. Field of the Invention

This invention is related to communications systems and methods, and in particular to systems and methods for allowing users to engage in social shopping online by browsing and shopping together in real time on the World Wide Web.

2. Prior Art

According to the Census Bureau of the United States Department of Commerce, E-commerce sales in the third quarter of 2007 accounted for only 3.4 percent of the total quarterly retail sales in the United States (http://www.census.gov/mrts/www/data/html/07Q3.html). While online shopping may be more convenient, it is not surprising that it is still a relatively small portion of overall retail sales. Among other factors, shopping online is not an enjoyable social activity as traditional offline shopping can be. In spite of this ongoing challenge for the past 10 years since the inception of eCommerce, a Mother and daughter living in their respective houses currently still can not go shopping together online in real time in the same manner that we can at the local mall or outlets.

The extant options for social shopping online have not been able to provide a simultaneous shopping experience, but instead provides reviews of shopping sites that reflect the opinions of past visitors to an Internet site as a recent review of social shopping conducted by New York times indicates (Sep. 11, 2006, Technology, 11, http://www.nytimes.com/2006/09/11/technology/11ecom.html?partner=rssnyt&emc=rss)

Shopping is a social activity, and when people shop together, they feel more comfortable about what they're buying, are more likely to find something they like, and above all enjoy their experience. In an academic study published in the journal Environment and Behavior, Robert Sommer states “Consistent with social facilitation theory, groups spent more time in the store and purchased larger loads than did lone individuals” (Vol. 24, No. 3, 285-297, 1992). My insight is that the lack of simultaneous social browsing and shopping online has been a key impediment to economic growth of online shopping. I have identified a key obstacle to the growth of eCommerce, and have invented a system and method to overcome this obstacle.

Shopping websites such as Overstock.com, and Amazon.com have been trying to add that much-needed social layer in shopping over the past few years. They have incorporated user reviews, and for Overstock.com even user uploaded videos, to try and make the users feel as if they were shopping with friends. These friends tell them that “this is a better hat than this” or “i really think that this TV set is nice for watching movies”. The key problem is that this does not solve the problem of the lack of social connection while shopping, because the comments from a random person on the Internet is not as assuring as a good friend you know well.

This is especially true when regarding major purchases. People feel more comfortable investing alot of money in something when a friend or family member is agreeing that it would be a smart decision.

Online eCommerce is a relatively new market that has yet to be utilized to its fullest capacity. New changes must be implemented to overcome the barriers of traditional shopping and let eCommerce become a strong fabric of the World's economy. The Ginza Walk plugin is a new tool that can change the way online shopping is conducted and better emulate the social conditions of traditional shopping. Using the Ginza Walk plugin a friend from New York can shop online with a friend in England. They will share views of the same page in real time and can utilize the many functions of the Ginza Walk plugin to shop together.

### SUMMARY OF THE INVENTION

This invention will fundamentally improve the experience online so the world of eCommerce can realize its full potential by allowing the social participation of selected friends and family as invited by a user. The method and system described herein brings eCommerce 2.0 to the Web 2.0. Since the World Wide Web is no longer just a place to store information and is today a place where people connect and spend time and money, the way people use the Web has also been changing. This invention will allow users to browse websites together, and the uses of the invention are almost limitless.

The idea of the Ginza Walk plugin was inspired by the need to add a social dimension to online shopping, but this invention can enhance almost any social activity on the Web. Whether a few students are trying to find research together for class, or two friends looking for a new cd to purchase, the invetion has a endless supply of uses and practical online applications. In short, this online application finally gives the users a way to easily connect and share input while browsing and shopping on the World Wide Web, and is available at http://www.ginzawalk.com

### DRAWINGS AND DESCRIPTION IN PDF FORM

FIG. 1: Flow chart (establishing a session) starting with initiating user visits website, such as http://www.ginzawalk.com to download client component of the system.

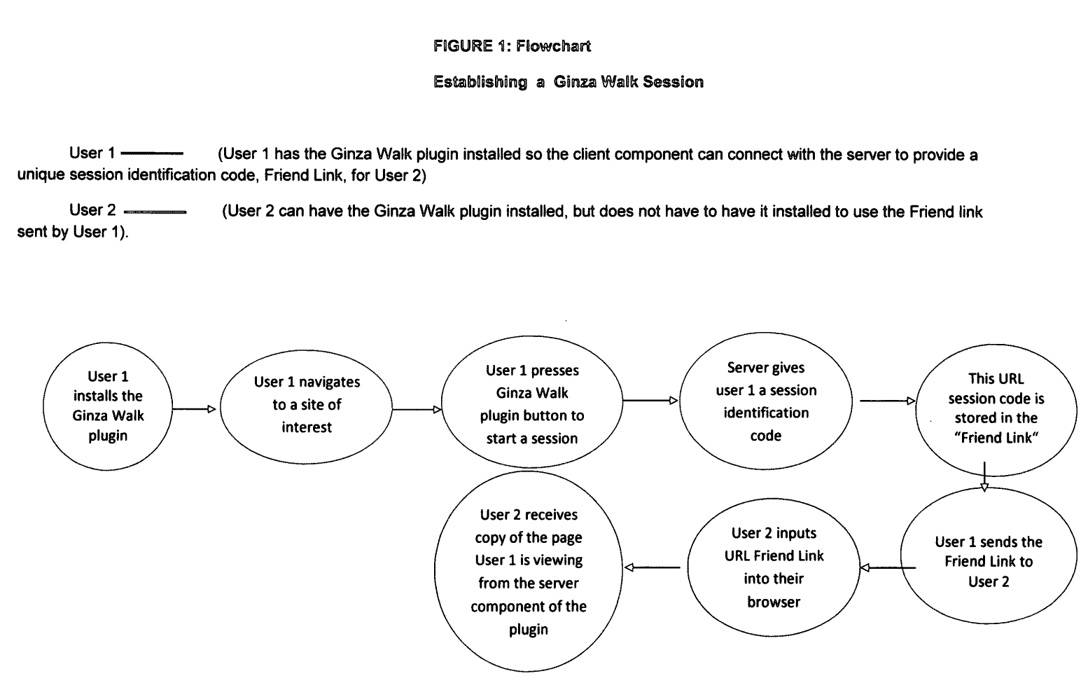

FIG. 2: Initiating User navigates to a site of interest

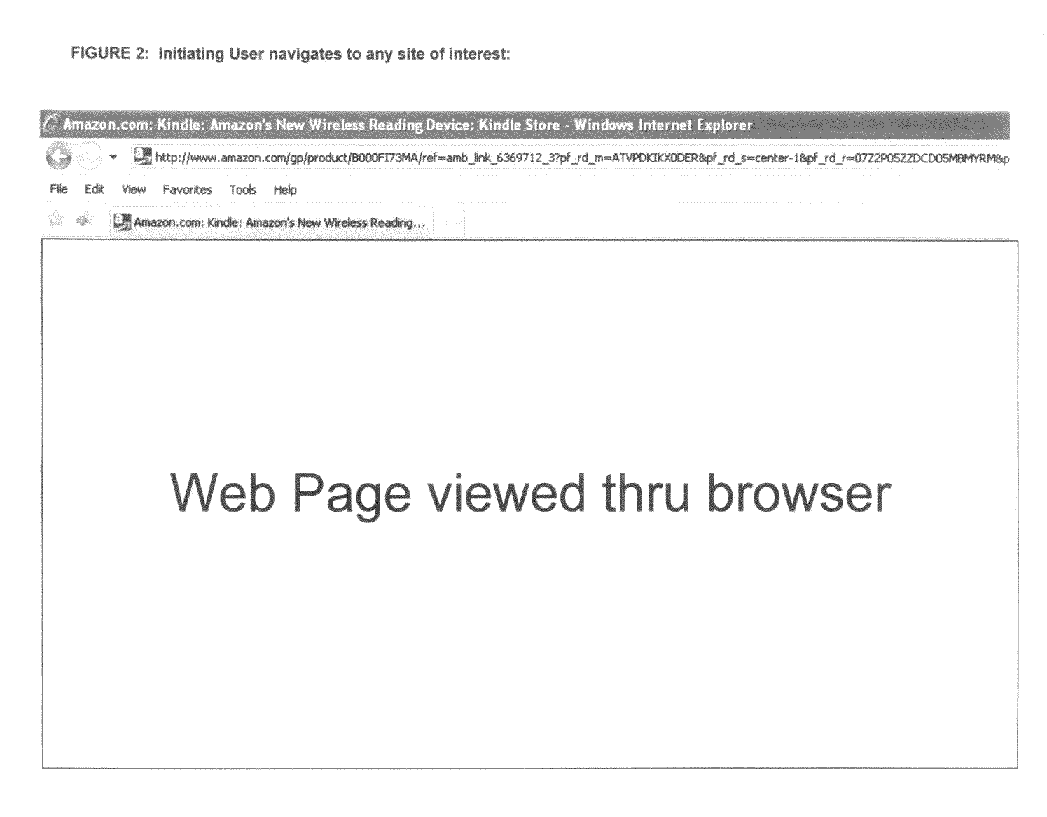

FIG. 3: Initiating User presses the Ginza Walk plugin button to launch a session.

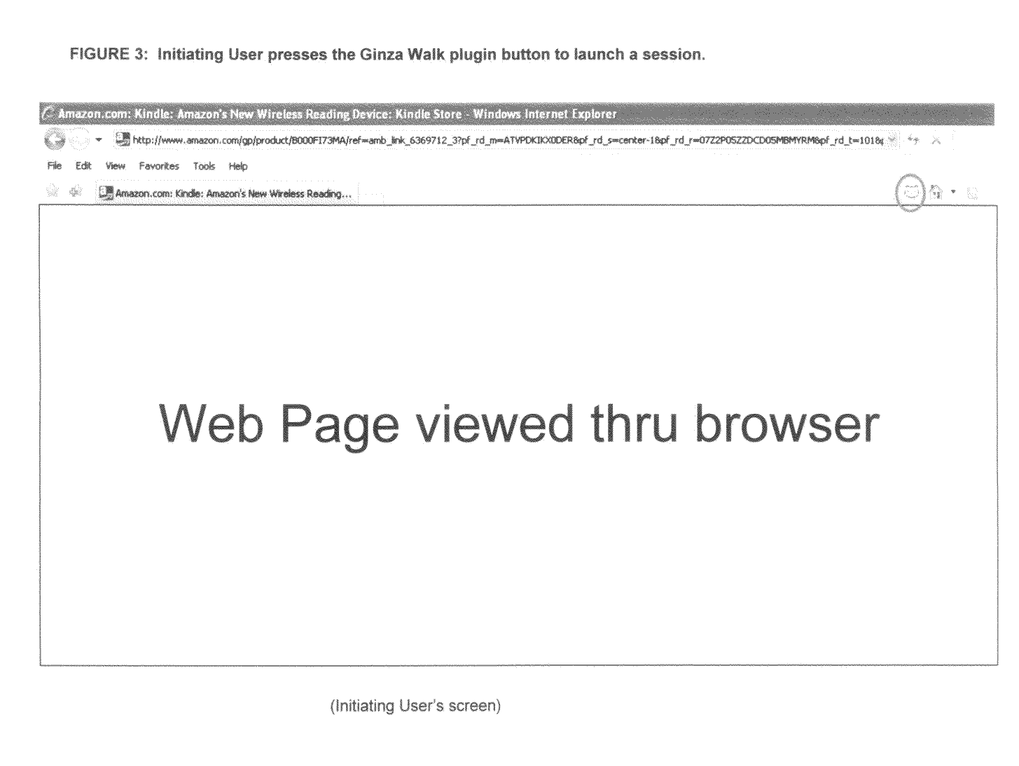

FIG. 4: Initiating User sends the unique session identification code stored in the “Friend Link” bar to invited User

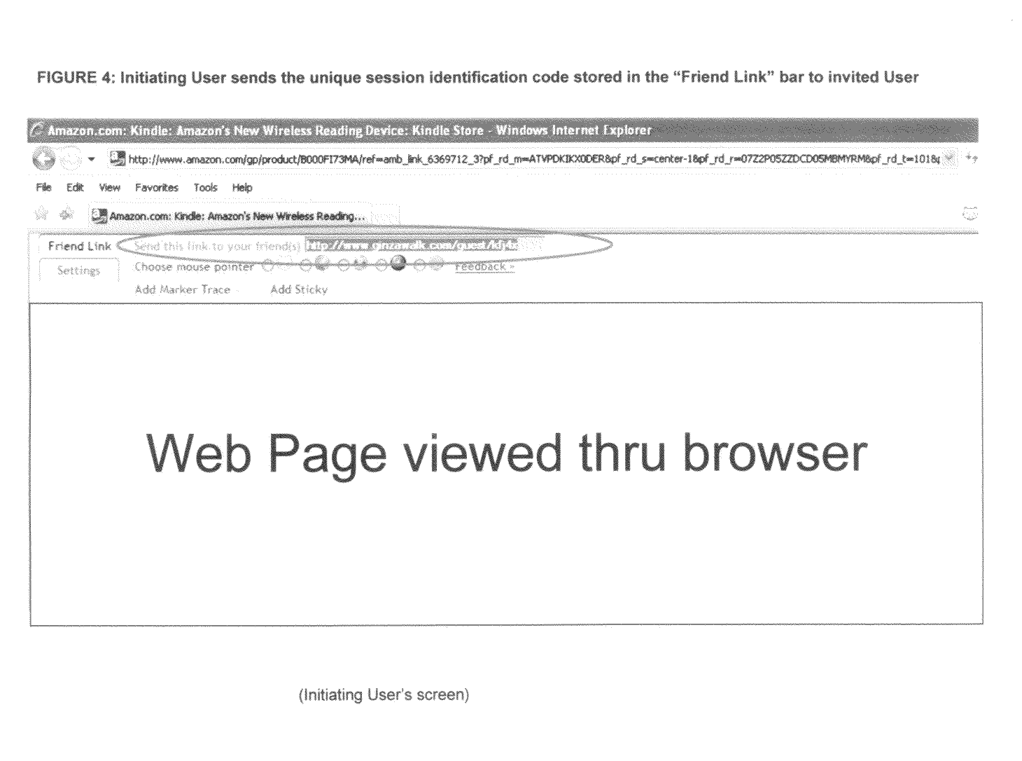

FIG. 5: Invited User inputs URL Friend Link into their browser

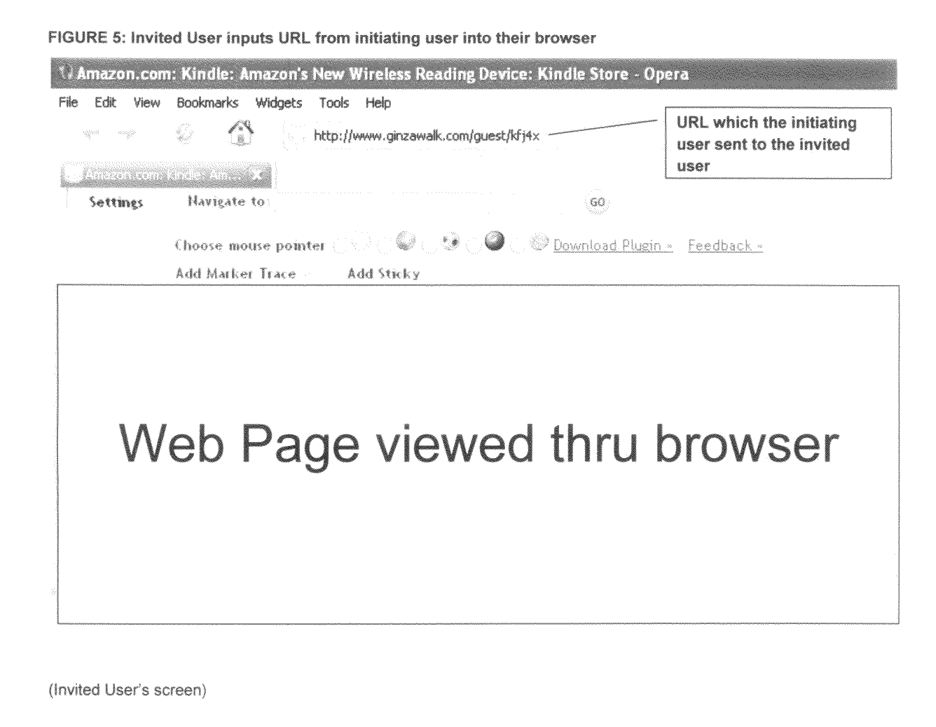

FIG. 6: The features of the Ginza Walk plugin

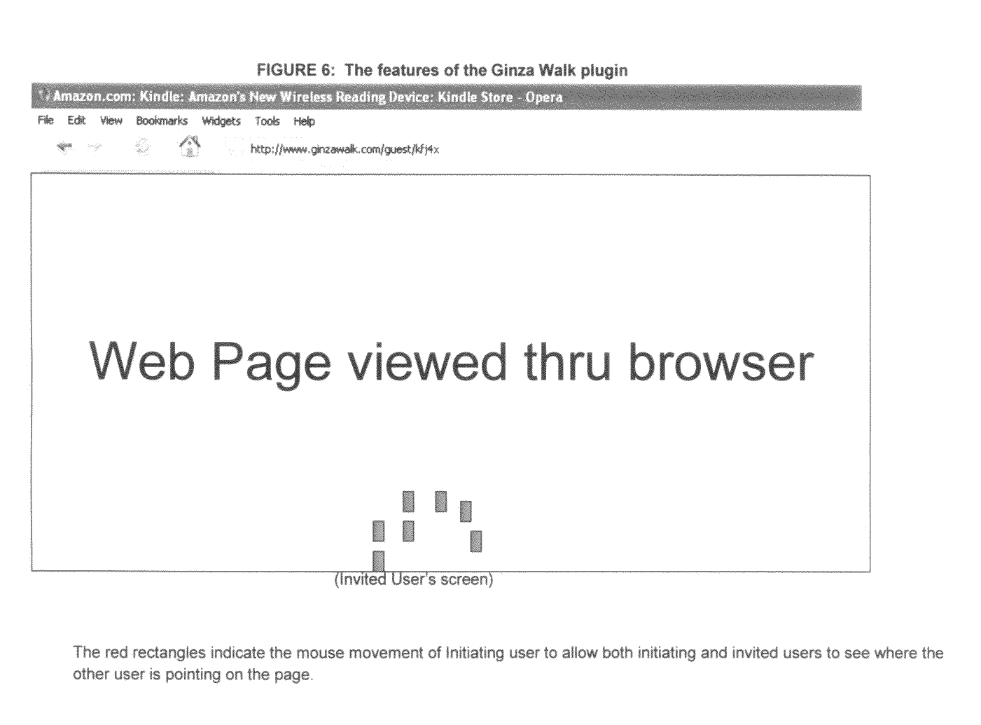

FIG. 7: Users may change what icon indicates the mouse movement by clicking an icon

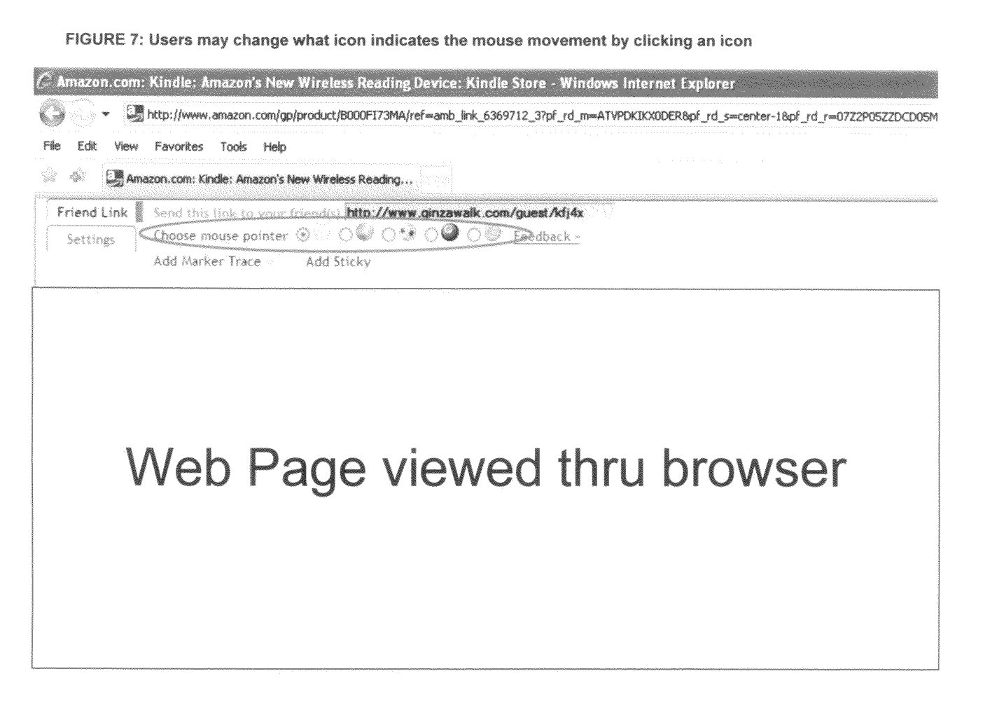

FIG. 8: Adding Stickys

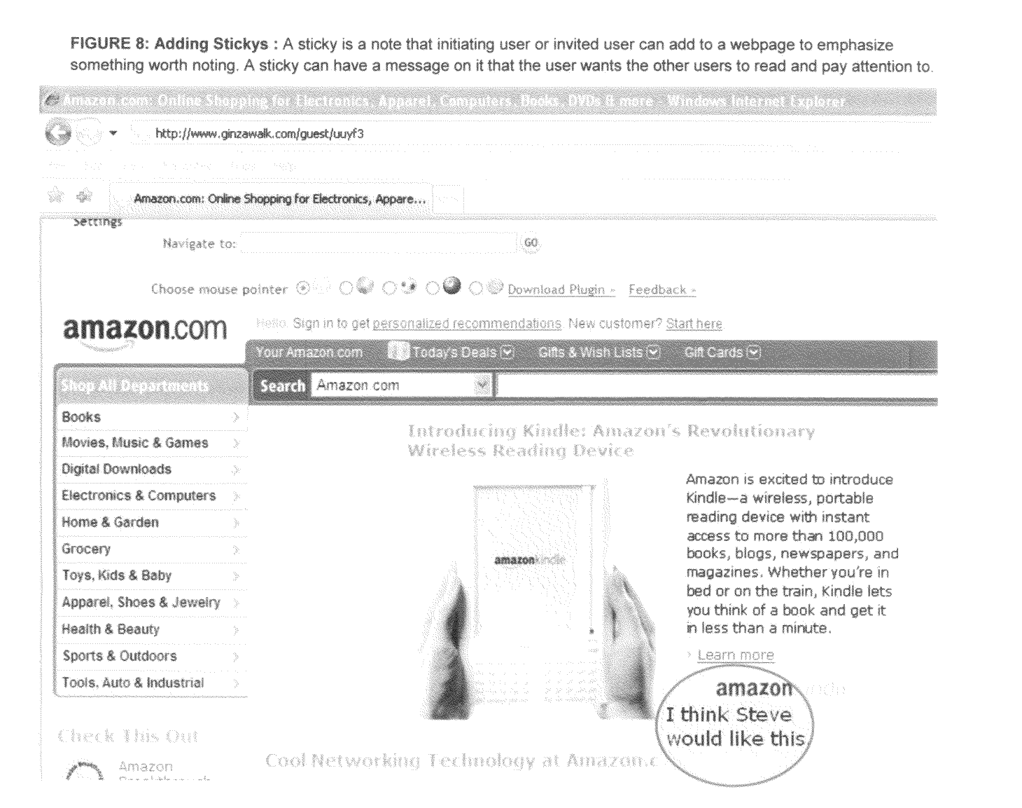

FIG. 9: Marker Trace

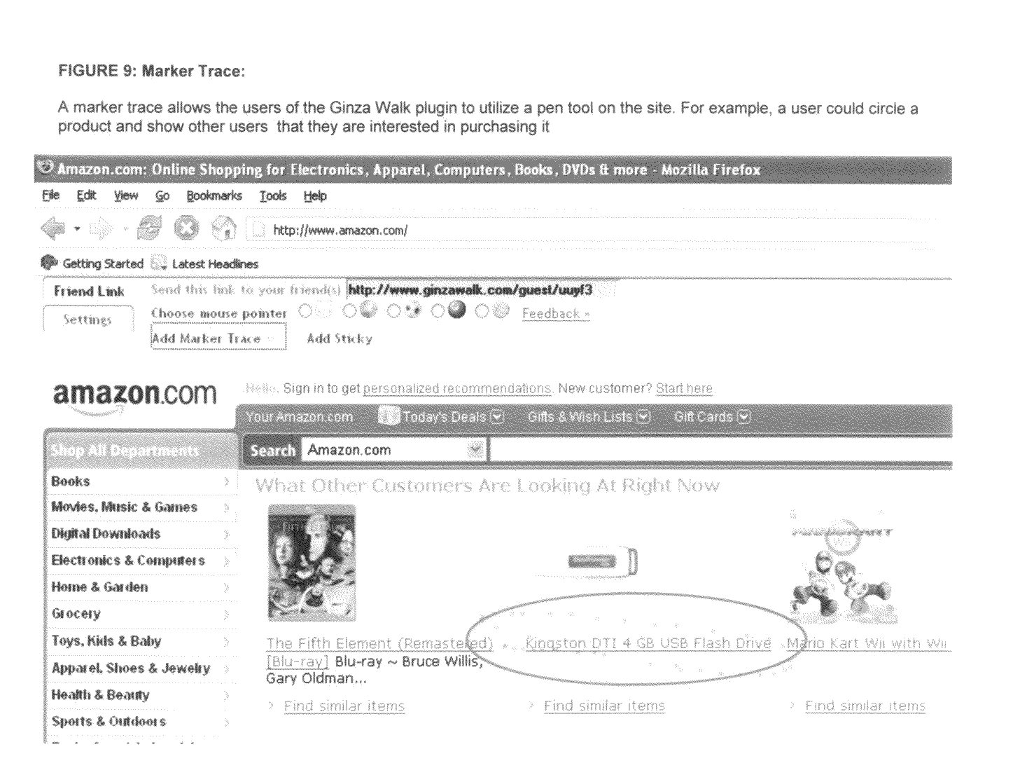

### DESCRIPTION

The heart of the Ginza Walk system is javascript and DHTML. Each time you visit a page, that page's HTML source code is uploaded and shared with your friends. This is accomplished by either a manual click on a favelet/booklet or by a browser plugin.

The activation process inserts a javascript file into the current page. The javascript file is downloaded off the Ginza Walk servers. Once the javascript file is inserted an initialization sequence is commenced.
1. The current page's DOM is uploaded to Ginza Walk servers.
2. A top bar is inserted. The top bar contains settings and personalization option and might contain useful link suggestions based on the current page.
3. Event listeners for keyboard presses and mouse clicks are created.
4. A “download connection” is established with the Ginza Walk servers. This link receives new events originating from your friends participating in the sharing session.

Once the initialization is complete, keyboard and mouse events are propagated to the Ginza Walk servers, and from there pushed out to other participants in the session. Friends participating in the session may now view each others mouse movements and keyboard inputs.

### CONCLUSIONS, RAMIFICATIONS, AND SCOPE

Accordingly the reader will see that, according to one embodiment of the invention, I have provided a system & method for multiple users to conduct online browsing & shopping together in real time.

While various embodiments of the present invention have been described above, it should be understood that they have been presented by way of example, and not limitation. It will be apparent to persons skilled in the relevant art(s) that various changes in form and detail can be made therein without departing from the spirit and scope of invention.

Thus, the present invention should not be limited by any of the above-described exemplary embodiments, but should be defined only in accordance with the following claims and their equivalents.

What is claimed is:

1. A method for allowing an initiating user and at least one additional invited user to browse and shop online together in a simultaneous session using their individual devices to access the Internet regardless of the physical distance separating the initiating user and any additional invited users.

2. The method according to claim 1 allows the initiating user and the additional invited users to view the position and trace of each others' pointing devices

3. The method according to claim 1 allowing the participating users to annotate the sharing page.

4. The method according to claim 1 allows the initiating user and the additional invited users to interactively see each others keyboard inputs.

5. The method according to claim 1 allows the initiating user and the additional invited users to navigate to new pages

6. The method according to claim 1 allows the initiating user and the additional invited users to each have distinct graphical icons to distinguish their pointing devices on each other's displays.

7. The method according to claim 1 allows the initiating user and the additional invited users to each have an area within their browser wherein messages, such as targeted product recommendations can be displayed by the server component or by the initiating or invited users.

8. The method according to claim 1 allows the initiating user and the additional invited users to pause, end, and restart the simultaneous online browsing and shopping session at the discretion of the initiating user or the invited users.

9. The method according to claim 1 can be used in social shopping or in browsing any other component of the Internet.

10. The method according to claim 1 can consist of a traditional server infrastructure or a P2P (peer-to-peer) network.

11. The method according to claim 1 accelerates the sharing of data through the use of compression.

12. A method for site owners, webmasters, or web application providers to enable their site to be shareable through the inclusion of code on each page that the webmaster wishes to enable for sharing

13. The method according to claim 12 can be metered for the site owners, webmasters, web application providers, or users to be pay a monetary fee per session or per pages shared or per final transaction value (CPA) or per bandwidth

14. The method according to claim 12 doesn't require the download and installation of code.
